(19) United States
(12) Patent Application Publication
(10) Pub. No.: US 2004/0236527 A1
(43) Pub. Date: Nov. 25, 2004

(54) Method and apparatus for synchronous viewing of asynchronous waveforms

(76) Inventor: Jimmie Doyle Felps, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/442,863

(22) Filed: May 21, 2003

(51) Int. Cl. G06F 19/00

(52) U.S. Cl. 702/67

(57) ABSTRACT

A method and apparatus for sequential multiple trigger event acquisition in a multiple measurement channel oscilloscope arms a first trigger event and responds to the first trigger event by acquiring a first set of data. The process then arms a second trigger event after the first trigger event, the second trigger event having different criteria than the first trigger event, and responds to the second trigger event by acquiring a second set of data. Both sets of data are then presented.

### BACKGROUND

Oscilloscopes are a traditional tool for test and troubleshooting of electronic devices. Certain dual beam analog oscilloscopes have two separate beams to represent measured data with the capability of sharing the same display. Each channel in the dual beam analog oscilloscope has a separate trigger. This configuration permits presentation of two asynchronous waveforms on the same CRT. Single beam analog oscilloscopes and conventional digital oscilloscopes do not have the dual beam capability. In certain troubleshooting applications, however, it is beneficial to view two waveforms with different triggers. Disadvantageously, the dual beam analog oscilloscopes are bulky and expensive and do not provide some of the enhanced data processing features available on digital oscilloscopes such as automated measurements, infinite persistence for multiple acquisitions of the same signal, digital filtering and digital data storage. An alternative to the dual beam oscilloscope is multiple oscilloscopes. Multiple oscilloscopes have cost disadvantages and inefficient lab bench space usage. Another alternative is a digital oscilloscope with memory that permits presentation of a stored waveform and an active waveform on the same display. Disadvantageously, each acquisition requires independent trigger set-up, which takes time and is prone to error. In certain troubleshooting applications, therefore, there remains a need to acquire and view two active asynchronous waveforms on the same display.

### SUMMARY

In an embodiment according to the teachings herein, a method for acquiring data in an oscilloscope comprises the steps of arming a first trigger event and responding to the first trigger event by acquiring a first set of data. The process then arms a second trigger event after the first trigger event, the second trigger event having different criteria than the first trigger event, and responds to the second trigger event by acquiring a second set of data. Both sets of data are then presented.

In another embodiment according to the teachings herein, an apparatus for acquiring analog information in a digital data format comprises first and second measurement channels, means for arming a first trigger event, means for responding to the first trigger event by acquiring a first set of data, means for arming a second trigger event after the first trigger event, the second trigger event having different criteria than the first trigger event, means for responding to the second trigger event by acquiring a second set of data, and a display for presenting the first and second sets of data.

### BRIEF DESCRIPTION OF THE DRAWINGS

FIG. 1 is a simplified block diagram of the basic components of a conventional digital oscilloscope.

FIG. 2 is a flow chart of a conventional method of arming an oscilloscope trigger.

FIG. 3 is a flow chart of an improved method of arming an oscilloscope trigger for viewing two or more asynchronous waveforms on the same display.

### DETAILED DESCRIPTION

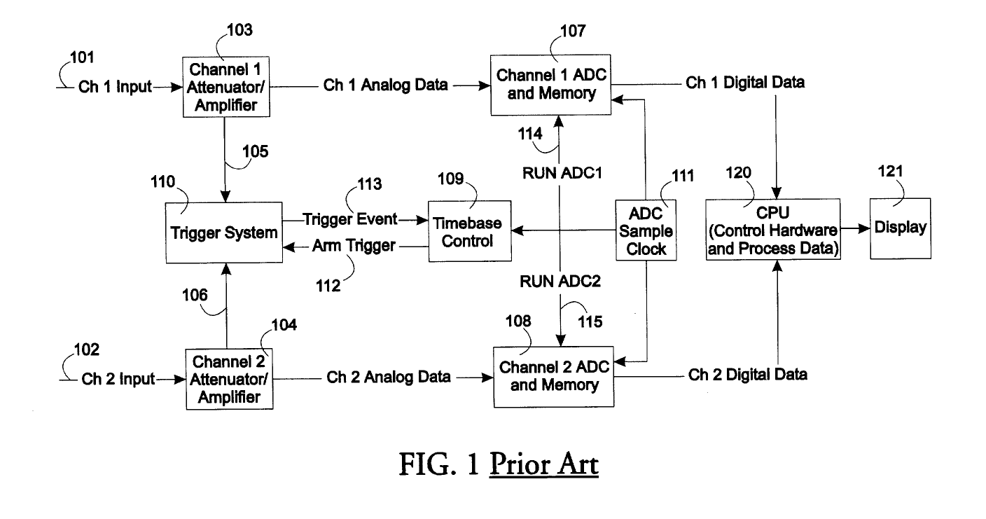

With specific reference to FIG. 1 of the drawings, there is shown a block diagram illustrating the basic functional blocks of a two channel digital oscilloscope. CPU 120 comprises a microprocessor that communicates with all functional blocks of the digital oscilloscope to program the various functional blocks to perform a particular task and to move acquired data as requested by a user. In an embodiment according to the present teachings, the CPU 120 runs an oscilloscope application program on a Windows based operating system. A user interface, available through a display 121, for configuring various options available on the digital oscilloscope is created using a Windows Visual C++ development environment.

The illustrated digital oscilloscope has a first measurement channel 101 and a second measurement channel 102 that receive electrical signals to be measured. Alternate embodiments include additional measurement channels to receive additional electrical signals to be measured. The remaining disclosure is directed primarily to the two-channel embodiment. One of ordinary skill in the art, however, may adapt the present teachings to the additional measurement channels. The first and second measurement channels 101, 102 present electrical signals to first and second channel attenuator/amplifiers 103, 104, respectively. The electrical signal present at the first and second measurement channels 101, 102 are attenuated or amplified by the attenuator/amplifiers 103, 104 and a voltage offset may be applied to place a total voltage range of the respective electrical signals within a dynamic range of first and second analog to digital converters (“ADC”) 107, 108. A known ADC range that is appropriate for purposes of the present teachings is 0-3 volts and the range is represented using 8 bits, however, any type of ADC may be used depending upon other factors not related to the present teachings. Each ADC is connected to and associated with a respective memory block 107, 108. Analog data representing the sampled electrical signal for each measurement channel 101, 102 that is digitized by the ADCs 107, 108 is stored in the respective memory block 107, 108 for retrieval, display, and analysis. A typical memory depth in a digital oscilloscope is anywhere from 125 kBytes to 64 Mbytes. A sample clock 111 is connected to the first and second ADCs 107, 108. The sample clock 111 is also connected to a timebase control 109. In a specific embodiment, the sample clock 111 provides a programmable digitizing frequency for digitizing the measured signal(s) from the oscilloscope measurement channels 101, 102. The digitizing frequency is the rate at which the memory blocks 107, 108 store samples taken by the ADCs 107, 108. Accordingly, the timing relationship between the number of samples and the time interval the samples represent is known for purposes of retrieval and analysis by the CPU 120 and ultimate display.

The signal to be measured is routed to both the trigger system 110 as well as the channel amplifier/attenuators 103, 104. The trigger system 110 and channel input stages 103, 104 are independently buffered so that the circuitry on one does not affect the signal present at the other. The trigger system 110 is programmed by the CPU 120 to respond to an event, pattern or sequence of events present on the first or second measurement channels 101, 102. The trigger system 110 is independent of the acquisition system 107, 108. Accordingly, a trigger event on one channel can initiate acquisition on either channel. There are numerous conventional triggering events and all possible triggering events may be used in conjunction with the present teachings. A trigger event defines a point in time during signal acquisition at which the trigger event occurs. The trigger event may be at the beginning, anywhere in the middle, or at the end of signal acquisition. If the trigger event is in the middle or end of signal acquisition, the ADCs 107, 108 must acquire enough pre-trigger event data before it is able to respond to the trigger event. The timebase control 109, therefore, initiates data acquisition for a defined period of time to acquire a pre-trigger event portion of data before arming the trigger event. The memory blocks 107, 108 are circular memories whereby newly acquired data overwrites the oldest data until the trigger event occurs. When sufficient pre-trigger data is acquired, the timebase control 109 issues an arm trigger signal 112 to the trigger system 110. The arm trigger signal acts as a gate and enables a trigger event 113 to be passed along to the trigger system when the trigger event occurs. Upon detection of the specified trigger event, a circuit within the timebase control 109 measures the absolute time between the trigger event 113 and a pre-determined post-trigger event ADC sample acquisition. In addition, the specified trigger event begins post-trigger event acquisition and storage of data. The timebase control 109 issues a stop acquisition control flag using first and second run ADC signals 114, 115, respectively after a post-trigger portion is acquired and stored. The memory blocks 107, 108 contain a circuit and a register in which a last memory address written value is recorded. The CPU 120 queries this register. By knowing the pre-trigger and post-trigger acquisition interval, the time interval between the trigger event and the pre-determined post-trigger event ADC sample, the sampling frequency of the data acquisition, and the last memory address written to each memory block 107, 108, the CPU 120 is able to retrieve and reconstruct the appropriate timing of the signals that were digitized on the first and second measurement channels 101, 102.

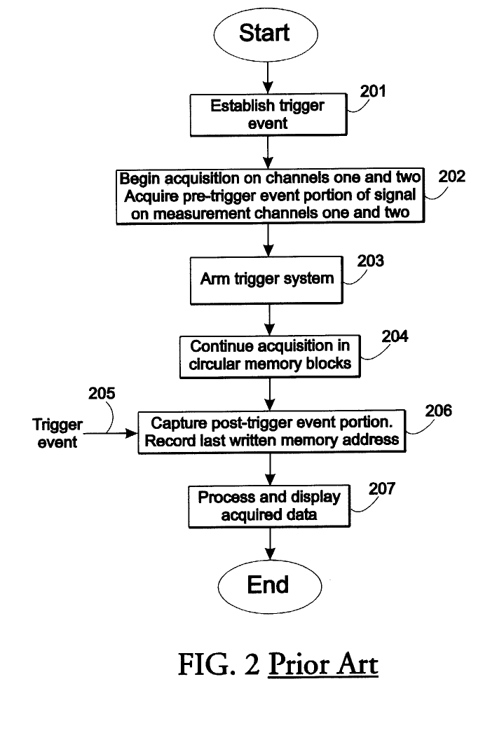

With specific reference to FIG. 2 of the drawings, there is shown a conventional method for triggering and acquiring data using the illustrated two-channel digital oscilloscope in a single trigger event data acquisition process. In the conventional method, either measurement channel one 101, measurement channel two 102, or a combination thereof are established as a trigger source. Upon detection of the trigger event, data is captured on either measurement channel or simultaneously on both measurement channels 101, 102 and are displayed on the same time axis. In a specific example, after a user establishes 201 a trigger event, the CPU 120 programs the trigger system to recognize the established trigger event and acquisition begins on one or both measurement channels 101 or 102. Acquisition continues until an established pre-trigger event portion is stored 202 in the memory blocks 107, 108. When the pre-trigger event portion is stored in memory, the timebase control 109 arms 203 the trigger system 110 with the programmed trigger event. Digitization and storage 204 of the signal present at the measurement channel(s) continues as the oscilloscope waits for the trigger event. Upon detection 205 of the trigger event, the post-trigger event portion is stored in the memory blocks 107, 108 and the last address written to the memory blocks is stored in an appropriate register 206. The CPU 120 then retrieves and processes 207 the data stored in the memory blocks 107, 108 for presentation on the display 121.

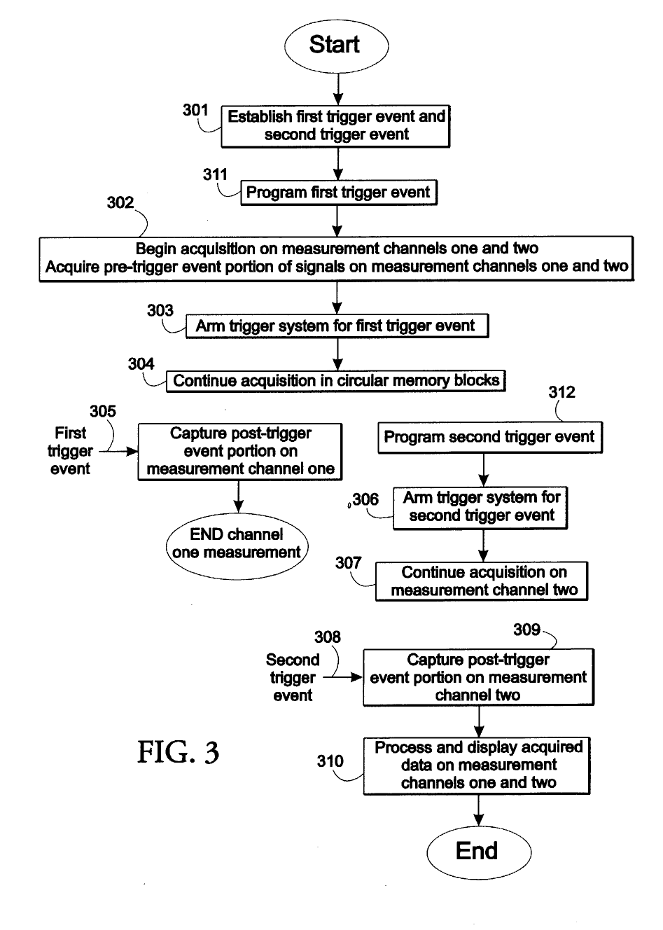

With specific reference to FIG. 3 of the drawings, there is shown a flow chart for an improved method of acquiring data in the digital oscilloscope illustrated in FIG. 1 of the drawings that permits sequential dual trigger event acquisition. As one of ordinary skill in the art appreciates, the teachings herein may be applied to other digital oscilloscopes with architectures that differ from the one illustrated in FIG. 1 while the description is discussed relative to the architecture in the illustration. In the new method, first and second trigger events are established 301 by the user. The CPU 120 programs 311 the trigger system 110 with the first trigger event and acquisition begins 302 on one or both measurement channels. In an oscilloscope with additional measurement channels, because each measurement channel has an independent ADC and memory block circuit (i.e. 107, 108), acquisition can occur on all available measurement channels as directed by the user. After a pre-trigger event portion is digitized and stored, the timebase control 109 arms 303 the trigger system for the first trigger event and acquisition continues 304 as the oscilloscope waits for the first trigger event to occur. As previously described, the memory blocks are circular memories so that a desired amount of pre-trigger event data is always available. Upon detection of the first trigger event 305, two processes occur in parallel. The ADC 107 captures and stores 306 the post-trigger event portion of the signal present on measurement channel one. The CPU 120 intervenes to program 312 the trigger system 110 to recognize the second trigger event. The timebase control 109 then arms 306 the trigger system 110 for the second trigger event 308 while the second ADC/memory block 108 continues acquisition 307 in the circular memory block for measurement channel two. Upon detection of the second trigger event 308, the timebase control 109 halts acquisition after storing the post-trigger event portion on the measurement channel two 309. The CPU 120, then retrieves the data stored in the memory blocks 107, 108 for processing 310 and presentation on the display 121 on the same time axis. Advantageously, a method according to the teachings of FIG. 3 permits viewing and comparison of two asynchronous waveforms on the same oscilloscope display 121. This is particularly helpful in certain troubleshooting applications. It is also an advantage, that the present teachings require only a software modification to a conventional digital oscilloscope, which permits a feature improvement without a change to the hardware manufacturing process. As one of ordinary skill in the art will appreciate, however, a method according to the present teachings may also be implemented with a hardware circuit to achieve certain efficiencies such as reducing a re-arming latency. At the time of the writing of this disclosure, however, it is believed that the software change is preferred because re-arming latency is not recognized as a limitation to the dual sequential triggering capability.

As mentioned herein, the teachings may be applied to digital oscilloscopes with more than two measurement channels. In such case, it is conceivable that each measurement channel may respond to a separate trigger event. It is also possible to establish a trigger event on measurement channel one 101 to direct acquisition on measurement channel two 102 and likewise to establish a trigger event on measurement channel two 102 to direct acquisition on measurement channel one 101. In addition, the improved method taught herein gives rise to further improvements such as independent sampling frequencies for each measurement channel and display of the data on independent horizontal time bases. This improvement, however, may require hardware as well as software modifications. Other modification will be apparent to one of ordinary skill given benefit of the present disclosure. A preferred embodiment being disclosed by way of illustrative example, the claims, however define the scope of the present invention.

1. A method for acquiring data in an oscilloscope comprising the steps of:
arming a first trigger event,
responding to said first trigger event by acquiring a first set of data,
arming a second trigger event after said first trigger event, said second trigger event having different criteria than said first trigger event,
responding to said second trigger event by acquiring a second set of data, and
presenting said first and second sets of data.

2. A method as recited in claim 1 wherein said first and second trigger events occur on first and second measurement channels, respectively.

3. A method as recited in claim 1 wherein said step of acquiring a first set of data comprises acquiring data on a first measurement channel and said step of acquiring a second set of data comprises acquiring data on a second measurement channel.

4. A method as recited in claim 1 wherein said step of presenting comprises displaying said first and second sets of data using a same time scale.

5. A method as recited in claim 1 wherein said first trigger event and said first set of data are based upon a signal present at a first measurement channel.

6. A method as recited in claim 1 wherein said first trigger event and said first set of data are based upon signals present at a first and second measurement channel, respectively.

7. A method as recited in claim 1 and further comprising the steps of arming a third trigger event, responding to said third trigger event by acquiring a third set of data.

8. A method as recited in claim 1 and further comprising the steps of arming a fourth trigger event, responding to said fourth trigger event by acquiring a fourth set of data.

9. An apparatus for acquiring analog information in a digital data format comprising:
first and second measurement channels,
means for arming a first trigger event,
means for responding to said first trigger event by acquiring a first set of data,
means for arming a second trigger event after said first trigger event, said second trigger event having different criteria than said first trigger event,
means for responding to said second trigger event by acquiring a second set of data, and
a display for presenting said first and second sets of data.

10. An apparatus as recited in claim 9 wherein said first and second trigger events occur on said first and second measurement channels, respectively.

11. An apparatus as recited in claim 9 wherein said first set of data is based upon a signal present on said first measurement channel and said second set of data is based upon a signal present on a second measurement channel.

12. An apparatus as recited in claim 9 wherein said first and second sets of data are presented on said display using a same time scale.

13. An apparatus as recited in claim 9 wherein said first trigger event and said first set of data are based upon a signal present at said first measurement channel.

14. An apparatus as recited in claim 9 wherein said first trigger event and said first set of data are based upon signals present at said first and second measurement channels, respectively.

15. An apparatus as recited in claim 9 and further comprising a means for arming a third trigger event and a means for responding to said third trigger event by acquiring a third set of data.

16. An apparatus as recited in claim 9 and further comprising a means for arming a fourth trigger event and a means for responding to said fourth trigger event by acquiring a fourth set of data.
